(19) United States
(12) Patent Application Publication
(10) Pub. No.: US 2024/0181713 A1
(43) Pub. Date: Jun. 6, 2024

(54) ENERGY LEVELS FOR FUSING ENERGY MODULES

(71) Applicant: Hewlett-Packard Development Company, L.P., Spring, TX (US)

(72) Inventors: Albert RIPOLL OLIVERAS, Sant Cugat del Valles - Barcelona (ES); Jordi BAUTISTA BALLESTER, Sant Cugat del Valles - Barcelona (ES); Ferran ESQUIUS BERENGUERAS, Sant Cugat del Valles - Barcelona (ES); Arnau CODINA SABORIT, Sant Cugat del Valles - Barcelona (ES)

(73) Assignee: Hewlett-Packard Development Company, L.P., Spring, TX (US)

(21) Appl. No.: 18/285,794

(22) PCT Filed: Apr. 14, 2021
(86) PCT No.: PCT/US2021/027295

§ 371 Date: Oct. 5, 2023

(51) Int. Cl. B29C 64/393; B29C 64/165; B29C 64/171; B29K 75/00; B29K 77/00; B33Y 10/00; B33Y 30/00; B33Y 50/02; B33Y 80/00

(52) U.S. Cl. CPC B29C 64/393; B29C 64/165; B29C 64/171; B33Y 10/00; B33Y 30/00; B33Y 50/02; B33Y 80/00; B29K 2075/00; B29K 2077/00

(57) ABSTRACT

A method includes processing circuitry acquiring a first indication of an extent of fusion of build material forming a first object generated by an additive manufacturing apparatus. A second indication of an extent of fusion of build material forming a second object generated by the additive manufacturing apparatus in a second additive manufacturing operation may also be acquired, wherein in the first operation, the fusing energy modules are controlled to provide energy at a first energy level and in the second operation, the fusing energy modules are controlled to provide energy at a second energy level, different from the first energy level. An energy contribution of each of the fusing energy modules to a zone of the additive manufacturing apparatus in which the first and second objects were generated may be determined and based on the indications of extent of fusion and the contributions of the fusing energy modules.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification and/or binding methods may be used.

### BRIEF DESCRIPTION OF DRAWINGS

Non-limiting examples will now be described with reference to the accompanying drawings, in which:

FIG. 1 is an example method of determining a calibrated energy level for at least one fusing energy module for use in additive manufacturing;

FIG. 2 is another example method of determining a calibrated energy level for at least one fusing energy module for use in additive manufacturing;

FIG. 3 shows an example arrangement of objects on a print bed;

FIG. 4 illustrates an example of how a calibrated energy level may be inferred;

FIG. 5 is an example of an apparatus;

FIG. 6 is another example of an apparatus; and

FIG. 7 is an example machine-readable medium associated with a processor.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a print bed and processed layer by layer, for example within a fabrication chamber. According to one example, a suitable build material may be PA12 build material commercially referred to as VIR10A “HP PA12” available from HP Inc. Other example build materials comprise PA11 material, commercially referred to as VIR12A “HP PA11”, Thermoplastic Polyurethane (TPU) materials, Thermoplastic Polyamide materials (TPA), and the like.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be determined from structural design data). The data may be derived from a digital or data model of the object. The fusing agent may have a composition which absorbs energy such that, when energy (for example, heat) is applied to the layer, the build material to which it has been applied heats up, coalesces and solidifies, upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. Such a fusing agent may comprise any or any combination of an infra-red light absorber, a near infra-red light absorber, a visible light absorber and a UV light absorber. Examples of fusing agents comprising visible light absorption enhancers are dye based colored ink and pigment based colored ink, such as inks commercially referred to as CE039A and CE042A available from HP Inc.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, detailing agent may be used near edge surfaces of an object being printed to reduce coalescence. According to one example, a suitable detailing agent may be a formulation commercially referred to as V1Q61A “HP detailing agent” available from HP Inc. A coloring agent, for example comprising a dye or colorant, may in some examples be used as a fusing agent or a coalescence modifier agent, and/or as a print agent to provide a particular color for the object.

As noted above, additive manufacturing systems may generate objects based on structural design data. This may involve a designer determining a data model of an object to be generated, for example using a computer aided design (CAD) application. The model may define the solid portions of the object. To generate a three-dimensional object from the model using an additive manufacturing system, the model data can be processed to define slices or parallel planes of the model. Each slice may define a portion of a respective layer of build material that is to be solidified or caused to coalesce by the additive manufacturing system.

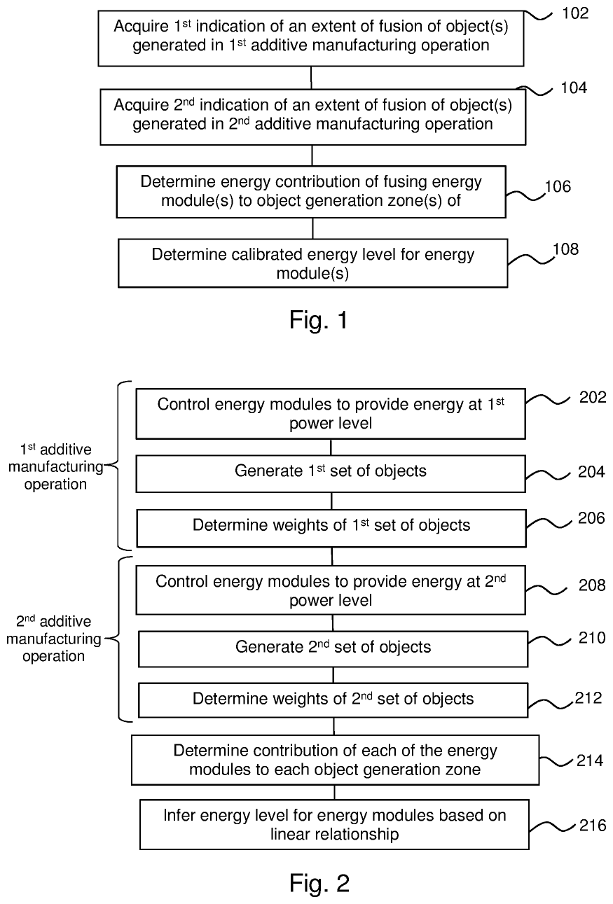

FIG. 1 is an example of a method, which may comprise a computer implemented method for determining a calibrated energy level for at least one fusing energy module for use in additive manufacturing. In this example the method is carried out by processing circuitry, which may comprise at least one processor.

The method comprises, in block 102, acquiring a first indication of an extent of fusion of build material forming at least a first object generated by an additive manufacturing apparatus in a first additive manufacturing operation. In some examples, the extent of fusion may comprise, or be derived from, a measured physical property of the object. In this example, the additive manufacturing apparatus comprises a plurality of fusing energy modules. For example, it may comprise a number of heat lamps such as infrared heat lamps. In another example, an array of LEDs may be provided. In some examples, there may be an array of many, for example hundreds or several thousand, LEDs, nominally separated into a number of modules, each of which is controlled together and thus comprises a single fusing energy module as the term is used herein. In other examples, the fusing energy modules may comprise another type of energy source.

During the first additive manufacturing operation, the fusing energy modules are controlled to provide energy with a first energy level. In some examples described herein, during the first additive manufacturing operation, all of the fusing energy modules may be controlled to provide energy at a common first energy level. For example, the specified energy level may be a percentage of their nominal maximum energy output. However, in other examples, fusing energy modules may be controlled such that each module provides energy at a first level for that module, but the energy output by one module is nominally different to the energy output by at least one other module. For example, the energy modules arranged above an edge of a print bed of an additive manufacturing apparatus may have a higher energy output level than those arranged above the centre of the print bed. In such an example, the first energy level may be provided by controlling the modules to output energy according to a first predetermined energy distribution pattern.

In some examples, the power supplied to the fusing energy modules may be controlled using pulse width modulation techniques, or by varying the absolute level of power supplied. In other examples, a voltage or current may be controlled so as to control an output power of a fusing energy module, or the output power may be controlled in some other way.

Due to manufacturing differences, individual fusing energy modules having nominally the same specification may output a slightly different power level from one another even when subjected to the same control instructions. Similarly, the irradiation pattern provided by one fusing energy module may be different from that provided by another fusing energy module, even when those modules are nominally the same. Moreover, while each fusing energy module may be associated with a particular zone of a print bed, fusing energy modules can have an effect on neighbouring zones. The amount of heat gained from a fusing energy module of a neighbouring zone may depend on whether a zone is in the centre of a print bed or at an edge. In addition, environmental effects may mean that some zones tend to be cooler than other zones. Furthermore, “re-radiation effects”, which result from a portion of the energy which is reflected from a print bed rather than being absorbed, may differ depending on the objects being generated in a given layer, the type of fusing agent, the arrangement of these objects and the like.

Such factors can contribute to an uneven temperature across a print bed, which may in turn impact the extent of fusion at a given location on a print bed. However, in some additive manufacturing printing techniques, it is intended to supply energy to the print bed in a consistent manner. Therefore, using the methods set out herein, the power output by each individual fusing energy module may be controlled to produce a more even effect.

In some examples, the indication of the extent of fusion of build material (also referred to as the degree of fusion herein) may be provided by or based on a measured physical property of generated object(s), for example, a weight or mass. The generated object(s) may have predetermined expected dimensions, and more generally a predetermined form and solid volume, and therefore the weight may provide a proxy for determining the amount of build material which has been incorporated into the object. Generally, in examples herein, a higher extent of fusion (which in turn is associated with a higher level of fusing energy) is associated with a greater weight. In some examples, the indication may for example comprise or be based on another physical property or attribute which may be measured, for example a strength or flexibility of the object(s) (a higher extent of fusion may be associated with a higher resistance to breaking in a strength test, and/or a lower amount of flexibility) and/or a density of the object (which may in some examples be inferred from the weight).

In some examples, the indication of the extent of fusion of build material may be provided by dimensions of an object. In some cases, an object which is subjected to a high extent of fusing may ‘grow’ as build material which is at least partially fused may be incorporated therein, or unfused build material may adhere to the surfaces thereof. However, in other examples, a high extent of fusion may be associated with a higher degree of shrinkage on cooling and thus a reduction in dimensions may be associated with a high extent of fusion. This can depend on factors such as, for example, the materials used.

In still further examples, small features may be present or absent depending on the extent of fusion undergone by the object. For example, small holes may close up when the extent of fusion of the object is high whereas the holes may remain open when the extent of fusion is lower. For example, holes of varying sizes could be used to indicate an extent of fusion, for example based on the smallest hole that remains open. Protrusions which are specified in object model data (which may be the basis on which the object is generated) may be absent at lower extents or degrees of fusion but present at higher degrees of fusion. For example, the determining smallest protruding feature which is successfully generated in a series of features of increasing size may give an indication of the extent of fusion. Other examples of measurable properties of generated objects may also provide proxies for the extent of fusion of the build material.

Returning to FIG. 1, the method further comprises, in block 104, acquiring a second indication of an extent of fusion of build material forming at least a second object generated by the additive manufacturing apparatus in a second additive manufacturing operation. During the second additive manufacturing operation, the fusing energy modules are controlled to provide energy with a second energy level, which is different from the first energy level. The second object may be generated in the same region of a fabrication chamber as the first object (e.g. nominally in the same position) and/or may comprise a nominally similar object (for example, an object based on the same object model data).

As is described above, supplying energy at the second energy level may comprise setting the energy levels of the fusing energy modules individually, but at least one fusing energy module is controlled to output energy at a different level to in the first additive manufacturing operation. Therefore, the second energy level may be provided by controlling the modules to output energy according to a second predetermined energy distribution pattern. In some examples herein, all of the fusing energy modules are set to output at least nominally the same amount of power (or the energy distribution pattern is flat). For example, while the first energy level maybe based on controlling the fusing energy modules to output power at around 70%, 75% or 80% of their nominal maximum output, the second energy level may be based on controlling the fusing energy modules to output power at around 80%, 85% or 90% of their nominal maximum energy output.

Block 106 comprises determining an energy contribution of each of the fusing energy modules (i.e. each individual module) to a zone of the additive manufacturing apparatus in which the first and second objects were generated. As will be discussed in greater detail below, where an array of fusing energy modules are provided above a print bed of an additive manufacturing apparatus, a given zone of the additive manufacturing apparatus may be positioned directly below an associated one of the fusing energy modules (noting that, in some examples, the position of a fusing energy module may change during object generation, for example being scanned over a surface of the print bed as discussed in greater detail below). Therefore, the energy contribution to that zone may largely be made by the associated fusing energy module. However, nearby fusing energy modules may also contribute to the zone and this may be taken into account as further set out below.

In block 108, the method comprises determining a calibrated energy level for at least one fusing energy module for use in subsequent additive manufacturing operations based on the indications of the extent of fusion and the contributions of the fusing energy modules to the extent of fusion (or the contributions of the fusing energy modules to the region of the fabrication chamber in which the object was generated). The calibrated energy level may for example be inferred so as to provide an object having an intended extent of fusion (e.g. a nominal weight, strength, flexibility, geometrical feature or the like). In some examples, as further set out below, determining the calibrated energy level comprises inferring an energy level which would (at least theoretically) result in an object having at least one nominal physical attribute, which may be a measurable physical property, for example based on a linear relationship between the total energy contributed to the zone and the acquired first and second indications of extent of fusion of the first and second object. In some examples, the calibrated energy levels may be determined so as to increase the consistency of the extent of fusion of objects generated at different positions in a print bed (e.g. in different zones of the print bed).

FIG. 2 provides an example of the method of FIG. 1. Block 202-206 may provide an example of the method of block 102 described in relation to FIG. 1. In this example, in block 202, in the first additive manufacturing operation, the fusing energy modules are controlled to provide energy at a common first power level. In this example, the common first power level is set to be X % of the nominal maximum power output level of each fusing energy module (the fusing energy modules in this example having the same nominal maximum power output level).

The first additive manufacturing operation further comprises, in block 204, generating a first set of objects. The objects of the first set of objects all have a substantially common intended design, or to put it another way, are intended to be different instances of substantially similar, or the same, objects generated based on similar, or the same, underlying object model data. In some examples, the objects of the first set of objects may be nominally the same except for an identifying feature, for example a number, letter(s) or the like, which may be generated in relief or in color or the like as part of the object generation operation. In other examples, an identifier may be provided in some other form.

In some examples, the object model data models objects having length and width dimensions which are greater than the height, in the orientation in which the objects are intended to be generated. In other words, the objects may have a relatively flat tablet like form. This means that the objects can be generated in relatively few layers, thus decreasing the time taken to generate the set of objects. In addition, in some examples, the object model data describes an object having a lattice body. In other words, the object body is intended to comprise struts formed around a plurality of voids. This serves to reduce the amount of build material which forms part of the object (noting that, in some examples, unfused build material may be recycled in subsequent additive manufacturing operations) while still sampling the fusing behaviour over a relatively large area of the print bed. In addition, such an object may be relatively variable depending on the extent of fusion. For example, if the fusing energy modules cause ‘over fusing’, the voids may at least partially close up. However, if the power output of the fusing energy module is too low, at least some of the struts may fail to form.

In this example, the set of objects generated are regularly distributed over the surface of the print bed. For example, the surface may be conceptually divided into a regular grid, and an object is generated in each cell of the grid. The objects are generated over a plurality of common layers, such that they are formed at the same height in the additive manufacturing fabrication chamber.

Once generated, in this example, the objects are removed from the additive manufacturing apparatus (for example, being ‘decaked’ from surrounding unfused build material, and being cleaned) and, in block 206, each object is weighed. In some examples, the location of generation may be associated with objects as they are weighed. As noted above, in some examples, the objects may be generated so as to have an identifier in order to facilitate this. In some examples, the identifier may be selected such that it does not cause a significant change to the weight of one object compared to another.

In this example, the additive manufacturing apparatus is then reset, cleared and/or cleaned as necessary and a new additive manufacturing operation is started using an empty fabrication chamber. While in principle, the second additive manufacturing operation could continue after the first additive manufacturing operation, for example following a few layers of blank build material (i.e. build material to which no agent is applied), starting both of the additive manufacturing operations in clean fabrication chambers provides for a more direct comparison between the two additive manufacturing operations, reducing the number of possible variables.

The following blocks 208-212 may provide an example of the method of block 104 described in relation to FIG. 1.

In block 208, in the second additive manufacturing operation, the fusing energy modules are controlled to provide energy at a common second power level, which in this example is Y % of the nominal maximum power output level of the fusing energy modules, and a second set of objects is generated (block 210). The same object generation instructions that were used for generating the first set of objects are used such that, nominally at least, the same set of objects will be generated in block 210. Other than the power level, the first and second additive manufacturing operations may be controlled so as to be as similar as possible to one another, or nominally the same.

In a particular example, the values of X and Y may be high enough to result in at least some fusion, for example being at least around 60% or at least around 70% of the maximum nominal power output of a suitable fusing energy module. In addition, the values of X and Y may be separated by a reasonable separation, for example by at least around 5%, in order to provide differentiation between the power levels. For example, the values of X and Y may be in the region of 70% to 98%, and may be separated by at least 5%. In an example providing data which is further discussed below, the values of X and Y were respectively 75% and 85%.

In block 212, the second set of objects is removed from the additive manufacturing fabrication chamber and weighed to provide the indication of the extent of fusing. As described above, this may comprise decaking and cleaning, while maintaining an association between each object and its location of generation.

In block 214, which may be an example of a method of carrying out block 106 of FIG. 1, determining the contribution of each of the fusing energy modules comprises determining the contribution of each of the fusing energy modules to each of a plurality of zones, wherein an object is generated in each of the zones in the first and second additive manufacturing operations.

The impact of each fusing energy module on each zone of the print bed depends on the layout of the fusing energy modules. In an example described below, the fusing energy modules are strips of LEDs, which together span a print bed in one dimension, and which are scanned over the print bed in an orthogonal direction. In this example, there are 12 such strips, each indexed 1 to 12 in the table below. In such an example, a matrix of energy contributions may be determined as follows (where empty cells indicate no substantial energy contribution):

TABLE 1

| | | Fusing energy modules | | | | | | | | | | | |
|---|---|---|---|---|---|---|---|---|---|---|---|---|---|
| | | 1 | 2 | 3 | 4 | 5 | 6 | 7 | 8 | 19 | 10 | 11 | 12 |
| Zones | 1 | 0.504 | 0.227 | 0.021 | | | | | | | | | |
| | 2 | 0.227 | 0.504 | 0.227 | 0.021 | | | | | | | | |
| | 3 | 0.021 | 10.227 | 0.504 | 0.227 | 0.021 | | | | | | | |
| | 4 | | 0.021 | 0.227 | 0.504 | 0.227 | 10.021 | | | | | | |
| | 5 | | | 0.021 | 0.227 | 0.504 | 0.227 | 10.021 | | | | | |
| | 6 | | | | 0.021 | 0.227 | 0.504 | 0.227 | 0.021 | | | | |
| | 7 | | | | | 0.021 | 0.227 | 0.504 | 0.227 | 10.021 | | | |
| | 8 | | | | | | 10.021 | 0.227 | 10.504 | 10.227 | 10.021 | | |
| | 9 | | | | | | | 0.021 | 0.227 | 0.504 | 0.227 | 0.021 | |
| | 10 | | | | | | | | 10.021 | 10.227 | 0.504 | 0.227 | 0.021 |
| | 11 | | | | | | | | | 10.021 | 0.227 | 0.504 | 0.227 |
| | 12 | | | | | | | | | | 0.021 | 0.227 | 10.504 |

In other words, in this example, a given fusing energy module provides around half of its energy to an associated print bed zone. In some examples, the print bed zones have a similar footprint to an associated fusing energy module and are provided directly below the fusing energy module. In a particular example described herein, each fusing energy module extends the width of the zone in one dimension but is swept through that zone in the other dimension. In use therefore, the fusing energy module may be swept across the zone to provide an effective footprint which corresponds to the footprint of the zone, and the above matrix may represent how energy is provided to the bed in total as the fusing energy module is moved. In other examples, a fusing energy module may be a different shape and/or may have its output directed by optical components such as lenses, mirrors or the like such that the energy is incident on a given region of the bed. In this example, each fusing energy module also provides energy to at least one neighbouring zone. Towards the edge of the print bed, some energy may be lost to the environment.

It will be appreciated that the energy distribution matrix may vary, in some examples significantly, from that set out in Table 1, based on the arrangement of fusing energy modules. For example, rather than being strips which are scanned across the print bed, the fusing energy modules provided may be statically positioned above the print bed, for example in a two-dimensional array. In addition, in some examples, fusing energy modules may vary in shape from one another. Moreover, some fusing energy modules may provide energy with a different area distribution (for example, in a manner which is more defused, or more focussed) than another fusing energy module. However, for a given arrangement of fusing energy modules, an energy distribution matrix such as the one in the table shown above may be determined by measurement and/or based on modelling of an energy distribution. Zones may also be defined in a manner which may be adapted to a given additive manufacturing apparatus.

In some examples, zones 1 and 12 represent an extended print bed. In other words, object generation may be generally carried out in zones 2 to 11 as the edges of the bed may be associated with a greater variability in temperature. However, in principle, object generation may be carried out in zones 1 to 12 in some examples.

In a particular example, in each build operation, a plurality of objects, which may be nominally identical—or at least very similar—objects, are generated in at least some zones (for example, each zone, or each of zones 2 to 11). Each object may be generated to lie entirely within a particular zone. Such an example is described in greater detail below. By generating a plurality of objects in a defined zone of the print bed, an average weight may be determined which may improve the robustness of the method.

In this example, block 214 comprises determining a power vector for each zone. The power vector may specify the total energy received by a given zone. For example, based on the table above, zone 2 and 6 respectively receive:

P_{zone2}=0.227*P_{FEM1}+0.504*P_{FEM2}+0.227*P_{FEM3}+0.021*P_{FEM4}

P_{zone5}=0.021*P_{FEM3}+0.227*P_{FEM4}+0.504*P_{FEM5}+0.227*P_{FEM6}+0.021*P_{FEM7}

Where P_{zonei} is the power (i.e. energy received per unit time) in zone i from each of a plurality of fusing energy modules (FEM), wherein fusing energy module i has an associated power level P_{FEMj}.

Mathematically, this may be expressed as:

[Rm]·[P_{FES}]=[P_{zone}].

Moreover, in examples herein, it is assumed that [P_{zone}] is proportional to [weights], where Rm is the radiation matrix (for example, as shown in the table above), P_{FEM} is the power vector, i.e. the power supplied by each fusing energy module, P_{zone} is a vector of the total power supplied to each zone and weights is a vector of the average weight of the objects generated in a given zone.

In other words, in this example, it may be assumed that the total power received by a given zone is proportional to the weight of the object(s) generated therein.

Block 216, which may comprise a method for carrying out block 108 of FIG. 1, comprises inferring an energy level which would result in an object having a nominal physical attribute (in this example, weight) based on a linear relationship between the total energy contributed to the zone and the acquired first and second indications of extent of fusion (in this example, the weights) of the sets of objects generated in the different additive manufacturing operations.

Similar analogies may be made for other attributes/physical properties of the generated objects, such as strength, flexibility or the like. In the case of weight, a linear relationship may be seen although other relationships may be modelled for other attributes.

Again, to express this mathematically:
[target weights] is proportional to [Rm]⁻¹·[P′_{FEM}], where P′_{FEM} is the matrix of the calibrated power output which may be used in a subsequent additive manufacturing operation.

In some examples, the calibrated energy levels may be determined so as to increase the consistency of the extent of fusion of objects generated at different positions in a print bed (e.g. in different zones of the print bed).

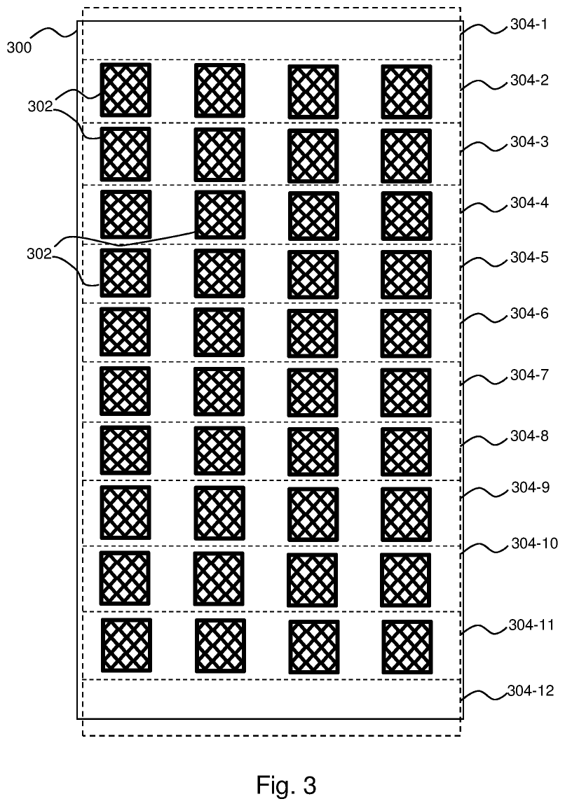

FIG. 3 shows an example of a print bed 300 having printed thereon a set of objects 302 (not all of which are labelled to avoid overcomplicating the Figure). To continue the example set out above, in this example, the fusing energy modules are provided as strips which taken together span one dimension of the print bed (the dimension which is shown vertically on the page). There are 12 fusing energy modules, each arranged over a strip of the print bed 300, and the effective footprint thereof is marked in dotted lines labelled 304-1 to 304-12. In this example, the strips run the width of the zone, and the effective footprint is achieved by scanning the strips across the zones (i.e. the fusing energy modules are mounted on a carriage which, during object generation, moves horizontally across the print bed 300 as shown in the Figure). In one example each fusing energy module comprises around 5 rows of LEDs. In this example, four objects 302 are generated in zones 2 to 11, and zones 1 and 12 are unused, and indeed the footprint of the fusing energy modules 304-1 and 304-12 lies partially outside the print bed 300. Although zones 1 and 12 could be used in other examples, there is an expectation that objects generated therein may be more variable due to the impact of the environmental temperatures and the like, and thus a more robust solution may be seen in some examples by not using these regions.

In this example, each fusing energy module is a separately controlled array of blue LEDs. There are a total of around 3000 LEDs, and each array comprises an equal number of nominally similar LEDs. Blue LEDs have been shown to provide good fusing performance for some additive manufacturing materials, although it will be appreciated that other fusing energy modules may be used, for example infrared sources, or laser fusing energy modules, such as Vertical-cavity surface-emitting lasers (VC-SEL) sources.

In an example, a first additive manufacturing operation was carried out with all the fusing energy modules set to output at 75% of their nominal maximum output (also referred to as an optical power output). For example, each of the 12 fusing energy modules may have a nominal maximum optical power output of ˜340 W. In this example, this means that each LED was nominally controlled to output power/energy at the same level, and that this control was provided by providing a control signal to each of the 12 modules (although it will be appreciated that due to manufacturing inconsistencies and the like, there may in practice be some variation between the output of individual LEDs/fusing energy modules).

In this example, all of the objects being generated are nominally the same and are generated using the same object model data. In this example, the objects were generated using TPA as the build material. The object models in this case describe a lattice tablet, measuring around 82 mm×82 mm in length and width and around 20 mm in height. The rows of objects were separated by around 10 mm. In table 2 below, the measured weights of individual objects are shown with the average weight of an object (Ave) in each zone (i.e. across a row of the table). The average weight of an object (Ave) in a zone was compared to the average weight of all the objects generated in the first additive manufacturing operation to provide difference data (Diff). The standard deviation (Std Dev) relates to the set of objects as a whole.

TABLE 2

| Zone | Weights (g) @ 75% max power | | | | Ave | Diff |
|---|---|---|---|---|---|---|
| 11 | 27.08 | 27.23 | 27.19 | 26.49 | 27.00 | 0.78 |
| 10 | 28.42 | 28.39 | 28.21 | 27.71 | 28.18 | 0.41 |
| 9 | 28.57 | 28.44 | 28.22 | 27.97 | 28.30 | 0.53 |
| 8 | 28.06 | 28.03 | 28.43 | 27.73 | 28.06 | 10.29 |
| 7 | 27.89 | 28 | 27.88 | 27.55 | 27.83 | 0.06 |
| 6 | 28.32 | 28.32 | 28 | 27.78 | 28.11 | 0.33 |
| 5 | 28.27 | 28.03 | 28.03 | 27.91 | 28.06 | 0.29 |
| 4 | 28.4 | 28.12 | 27.96 | 28 | 28.12 | 0.35 |
| 3 | 28.12 | 28.14 | 27.92 | 27.66 | 27.96 | 0.19 |
| 2 | 26.35 | 26.36 | 26.11 | 27.65 | 26.12 | −1.66 |

| | |
|---|---|
| Std Dev = 7.45 | 27.77 |

Certain observations may be made based on this data. In particular, it may be noted that the objects in zones 2 and 11, i.e. those closest to the edge of the bed, are ‘underweight’ compared to the average weight of 27.77 g whereas objects towards the centre of the bed tend to be slightly over the average weight. This may be because the edges of the bed tend to be somewhat cooler and, unless calibration is undertaken, the extent of fusion undergone by the objects in this region may be less than the fusion undergone by objects in the centre of the bed.

Nominally the same objects were then generated in nominally the same conditions in a second additive manufacturing operation, with the exception of the power output by the fusing energy modules, which was set to be 85% of the maximum power output, resulting in objects having the weights set out below being generated:

TABLE 3

| Zone | Weights (g) @ 85% max power | | | | Ave | Diff |
|---|---|---|---|---|---|---|
| 11 | 30.87 | 31.07 | 30.91 | 29.85 | 30.68 | −0.63 |
| 10 | 32.12 | 31.83 | 31.75 | 31.36 | 31.77 | 0.46 |
| 9 | 32.24 | 32.48 | 31.5 | 31.42 | 31.91 | 0.61 |
| 8 | 31.89 | 31.71 | 31.45 | 31.38 | 31.61 | 0.31 |
| 7 | 31.68 | 31.52 | 31.49 | 31 | 31.42 | 0.12 |
| 6 | 32.04 | 31.6 | 31.4 | 31.19 | 31.56 | 0.26 |
| 5 | 32.05 | 31.54 | 31.35 | 31.34 | 31.57 | 0.27 |
| 4 | 32.19 | 31.6 | 31.42 | 31.42 | 31.66 | 0.36 |
| 3 | 31.72 | 31.75 | 31.35 | 30.95 | 31.44 | 0.14 |
| 2 | 29.72 | 29.78 | 29.34 | 28.83 | 29.42 | −1.88 |

| | |
|---|---|
| Std Dev = 7.47 | 31.3 |

Here, the same trends as noted for the fusing operation carried out at 75% of the maximum fusing energy module power are again seen. However, the average object weight is higher, indicating a higher extent of fusion.

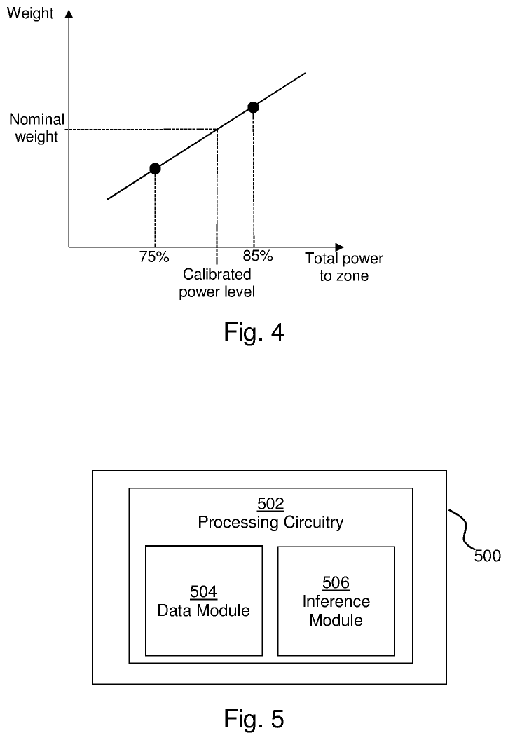

These two sets of data provide an output which can be used to infer a target power value (i.e. energy output) to be used in a subsequent build operation. The principal is illustrated schematically in FIG. 4, which shows how a nominal weight may be used to determine a calibrated power level for each zone. In this example, the nominal weight was 30 g.

In some examples, the calibration may be carried out zone by zone (for example using the weights of the object in a zone to calibrate the power output by the fusing energy module associated with that zone). In this example, however, the data was fitted across the zones to provide a solution for the whole print bed. In addition, in this example, zones 1 and 12 were set to their highest normal usage point, which in this example, to prolong the life of the components, was set to 95% of the theoretical maximum value, and further fitting for the remaining power levels was based on these power outputs being assigned, and subject to this highest normal usage point. For example, best fit, or curve fitting, techniques may be used, which may be subject to constraints such as the highest normal usage point.

The data fitting described above was then used in turn to derive a power output for each fusing energy module overlying a corresponding zone. As noted below, this varied between 74.9% and 95%. A subsequent build operation using the calibrated power output was carried out, again generating nominally the same objects as generated in the first and second additive manufacturing operation.

TABLE 4

| | Power (% | | | | | | |
|---|---|---|---|---|---|---|---|
| Zone | of max) | Weights (g) | | | | Ave | Diff |
| 12 | 95 | — | — | — | — | | |
| 11 | 84.6 | 30.73 | 30.26 | 30.05 | 29.43 | 30.12 | 0.23 |
| 10 | 79.5 | 30.67 | 30.38 | 30.06 | 29.71 | 30.21 | 0.31 |
| 9 | 79.2 | 30.47 | 29.93 | 29.52 | 29.42 | 29.84 | −0.06 |
| 8 | 80.4 | 30.13 | 29.75 | 29.61 | 29.42 | 29.73 | −0.16 |
| 7 | 81.9 | 29.88 | 29.64 | 29.64 | 29.25 | 29.60 | −0.29 |
| 6 | 79.9 | 30.25 | 29.72 | 29.74 | 29.58 | 29.82 | −0.07 |
| 5 | 80.3 | 30.11 | 29.62 | 29.44 | 29.47 | 29.66 | −0.23 |
| 4 | 82.2 | 30.25 | 29.68 | 29.8 | 29.75 | 29.87 | −0.02 |
| 3 | 74.9 | 30.53 | 30.18 | 30.06 | 29.96 | 30.18 | 0.29 |
| 2 | 95 | 30.22 | 30.04 | 29.79 | 29.52 | 29.89 | 0.00 |
| 1 | 95 | — | — | — | — | | |

| | |
|---|---|
| Std Dev = 3.68 | 29.89 |

It may be noted that the average weight of the objects is closer to the target weight, which in this example was 30 g. Moreover, the standard deviation is considerably reduced, indicating that the variability in object weights is also considerably reduced. It may be noted that, in some examples, the actual intended weight may be higher than a target weight. In some examples, the fusing energy modules may be calibrated to provide a consistent achievable weight, while in some examples staying within nominal ranges. For example, as noted above, it may be intended to operate the fusing energy modules at, at most, 95% of their nominal maximum output and a target weight may be selected in light of this. In some examples, other methods to increase energy absorption, or the use of other energy sources, may be employed to reach an actual target weight.

Thus, in a summary of one example, fusing energy modules are set to output energy at the same nominal level as one another during a first additive manufacturing operation. A first set of objects may be generated during that first additive manufacturing operation. The first set of objects may be generated based on the same, or similar, object model data for each object, such that they may be expected to have nominally the same, or similar, physical properties. A second additive manufacturing operation may then be carried out, in some examples with instructions to generate the same set of objects again using a different nominal output energy level. This allows data fitting (for example, a linear regression) which can determine, for each zone, a calibrated energy output for the associated fusing energy modules which would, theoretically at least, produce objects having, or at least being close to, their nominal property (e.g. a nominal or target weight). This calibrated energy output level can be used in subsequent build operations.

It may be appreciated that, in some examples, while the calibrated energy output level may be used as a base level during a subsequent additive manufacturing operation, there may be other control systems in place, such as a feedback loop to prevent overheating and/or to counter different environmental conditions.

FIG. 5 is an example apparatus 500, which may be used in some additive manufacturing operations, for example in calibrating energy outputs from fusing energy modules. The apparatus 500 comprises processing circuitry 502, the processing circuitry 502 comprising a data module 504 and an inference module 506.

In this example, in use of the apparatus 500, the data module 504 acquires first and second fusing data. The first fusing data is indicative of the degree (i.e. the extent) of fusion of build material in a first set of objects generated in a first additive manufacturing operation in which fusing energy modules are powered at a first power level and the second fusing data is indicative of the degree of fusion of build material of a second set of objects generated in a second additive manufacturing operation in which fusing energy modules are powered at a second power level. As noted above, the indication of the degree of fusion may be a measured physical property and/or may comprise a weight, strength, flexibility measurement, a dimension, an indication of a geometrical feature (e.g. a hole or protrusion) of a model which is absent/present in a generated object, or the like. The first and second power levels may be provided by controlling fusing energy modules to output power according to different first and second energy distributions. The data module 504 may acquire the first and second fusing data directly from measuring apparatus (for example, from a weighing device, or from a scanner which is able to ascertain the shape and/or dimensions of an object), or may acquire the data from memory or over a network or the like.

In this example, in use of the apparatus 500, the data module 504 further acquires an energy distribution matrix indicative of a contribution of each fusing energy module to generation of each object. For example, this may have a form similar to that discussed in relation to Table 1 above. In some examples, acquiring the energy distribution matrix may comprise measuring energy outputs of fusing energy modules, for example to determine the energy contribution of a fusing energy module to a portion or zone of a print bed in which the object was generated. In other examples, the energy distribution matrix may be generated based on theoretical principles. The matrix may be predetermined and acquired from a memory, over a network or the like.

In this example, in use of the apparatus 500, the inference model 506 infers, from the first fusing data; the second fusing data and the energy distribution matrix, a power level for each of the fusing energy modules in a subsequent additive manufacturing operation. In some examples, the first fusing data and second fusing data comprises data indicative of the weight of objects generated in the first and second additive manufacturing operations respectively. In such examples, and as described in greater detail above, the inference module 506 may infer the power level for each of the fusing energy modules in a subsequent additive manufacturing operation based on a linear regression of the weight data and an intended weight value. Data fitting techniques, such as curve fitting, may be used, and may be subject to constraints as described above.

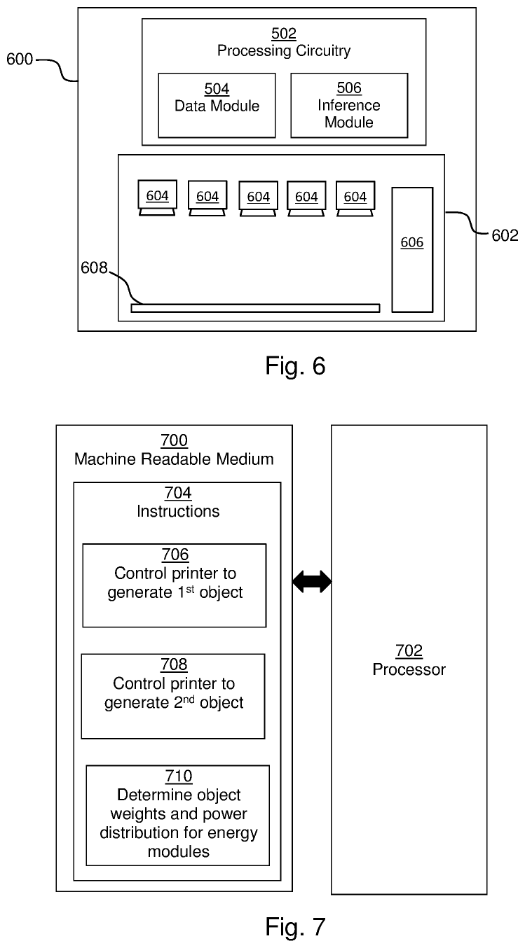

FIG. 6 shows an example of an apparatus 600 comprising the processing circuitry 502 of the apparatus of FIG. 5. In addition, the apparatus further comprises additive manufacturing apparatus 602 which may be used to generate objects using additive manufacturing. The additive manufacturing apparatus 602 comprises a plurality of fusing energy modules 604 and a controller 606. In use, the fusing energy modules 604 irradiate a print bed 608 (which may in practice comprise a removable component of the apparatus 602).

The additive manufacturing apparatus 602 may generate objects in a layer-wise manner by selectively solidifying portions of layers of build material formed on the print bed 608. The selective solidification may in some examples be achieved by selectively applying print agents, for example through use of ‘inkjet’ liquid distribution technologies, and applying energy, for example heat, to each layer using the plurality of fusing energy modules. In some examples, object model data modelling object(s) to be generated may be received and control instructions determined as to where to print agent on a layer of build material in order to generate a layer of the object. In some examples, the regions which comprise build material which is intended to fuse are determined, at least in part, by reference to control data used to instruct the distribution of print agents. Such control data may be generated based on object model data representing at least a portion of an object to be generated by an additive manufacturing apparatus by fusing build material. The object model data may for example comprise a Computer Aided Design (CAD) model, and/or may for example be a STereoLithographic (STL) data file.

In use of the apparatus 600, energy may be provided by the plurality of fusing energy modules 604 to cause the build material to which fusing agent has been applied to fuse. The controller 606, in use of the apparatus 600, controls the plurality of fusing energy modules 604. In particular, the controller 606 may control the fusing energy modules 604 to operate at the first power level during the first additive manufacturing operation, and to operate at the second power level during the second additive manufacturing operation. Moreover, in a subsequent additive manufacturing operation, the controller 606 may control each fusing energy modules 604 to operate according to the power level determined for that fusing energy module 604 by the inference module 506. In some examples, during the subsequent additive manufacturing apparatus, additional control measures (such as temperature feedback loops) may also be used in control of the power level. For example, the power level(s) determined by the inference module 506 may be used as an initial set point for the fusing energy modules 604.

The additive manufacturing apparatus 602 may comprise additional components not shown herein, for example a fabrication chamber, at least one print head for distributing print agents, a build material distribution system for providing layers of build material, carriages for sweeping the fusing energy modules 604 across the print bed 608 and the like.

The controller 606 may control other aspects of the additive manufacturing operation. For example, the controller 606 may control the formation of layers of build material and may control the action of a print head to provide print agents. The controller 606 may control additional energy modules, for example build material warming energy modules and the like.

The apparatus 500, 600 of FIG. 5 and/or FIG. 6 may, in some examples, carry out at least one of the blocks of FIG. 1 or FIG. 2.

FIG. 7 shows an example of a tangible machine readable medium 700 in association with a processor 702. The machine readable medium 700 stores instructions 704 which, when executed by the processor 702 cause the processor to carry out actions.

In this example, the instructions 704 comprise instructions 706 comprise instructions 706 to cause the processor 702 to control an additive manufacturing apparatus to generate a first instance of an object using a first power level for each of a plurality of fusing energy modules of the additive manufacturing apparatus. The instructions 704 further comprise instructions 708 to cause the processor 702 to control the additive manufacturing apparatus to generate a second instance of the object using a second, different, power level for each of the plurality of fusing energy modules. The instructions 704 further comprise instructions 710 to cause the processor 702 to determine the weights of the first and second instances of the object and, based on the weights and the energy contributed by the fusing energy modules to generating the first and second objects, determine a power level for the fusing energy modules in a subsequent build operation. For example, the power levels may be determined so that, in the subsequent build operation, the objects may tend to have an intended object weight, and/or to increase the consistency of weights of the objects. The processor may determine the weights by controlling a measurement of the objects, and acquiring the weights as part of that process, or by retrieving or receiving the data from a memory, or over a network, or the like. In other examples, an object property other than weight may be used as described above.

In some examples, the instructions 708 to control an additive manufacturing apparatus to generate a first instance of the object comprise instructions to control the additive manufacturing apparatus to generate a set of first instances of objects, wherein each first instance of an object is generated in an associated zone of the additive manufacturing apparatus. Moreover, the instructions 712 to control an additive manufacturing apparatus to generate a second instance of the object may comprise instructions to control the additive manufacturing apparatus to generate a set of second instances of objects, wherein each second instance of an object is generated in a location corresponding to a location of an object of the set of first instances. In some examples, as set out above, a plurality of objects may be generated in each of a plurality of zones. In some examples, the zones may be primarily associated with a particular fusing energy module. In some examples, the first and second set of objects each consist of instances of nominally the same object, or of nominally the same object except for an identifier.

In some examples, the machine readable medium 700 further comprises instructions to determine the energy contributed by each fusing energy module to each zone of the additive manufacturing apparatus and thereby determine an indication of the energy contributed by each fusing energy module to generating each object for use when executing the instructions 712.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that at least some blocks in the flow charts and/or block diagrams, as well as combinations of the blocks in the flow charts and/or block diagrams can be realized by machine readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus, functional modules of the apparatus and devices (such as the data module 504, the inference module 606 and/or the controller 606) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising, by processing circuitry:
acquiring a first indication of an extent of fusion of build material forming a first object generated by an additive manufacturing apparatus comprising a plurality of fusing energy modules in a first additive manufacturing operation;
acquiring a second indication of an extent of fusion of build material forming a second object generated by the additive manufacturing apparatus in a second additive manufacturing operation, wherein in the first additive manufacturing operation, the fusing energy modules are controlled to provide energy at a first energy level and in the second additive manufacturing operation, the fusing energy modules are controlled to provide energy at a second energy level, different from the first energy level;
determining an energy contribution of each of the fusing energy modules to a zone of the additive manufacturing apparatus in which the first and second objects were generated; and,
based on the indications of extent of fusion and the contributions of the fusing energy modules, determining a calibrated energy level for at least one fusing energy module for use in subsequent additive manufacturing operations.

2. A method according to claim 1 wherein in the first additive manufacturing operation, the fusing energy modules are controlled to provide energy at a common first power level and in the second additive manufacturing operation, the fusing energy modules are controlled to provide energy at a common second power level.

3. A method according to claim 1 wherein determining the calibrated energy level comprises inferring an energy level which would result in an object having a nominal physical attribute based on a predetermined relationship between the total energy contributed to the zone and the acquired first and second indications of extent of fusion of the first and second object.

4. A method according to claim 1 wherein:
acquiring the first indication of the extent of fusion comprises acquiring an indication of the weight of each of a plurality of objects generated in the first additive manufacturing operation;
acquiring the second indication of the extent of fusion comprises acquiring an indication of the weight of each of a plurality of objects generated in the second additive manufacturing operation;
determining the contribution of each of the fusing energy modules comprises determining the contribution of each of the fusing energy modules to each of a plurality of zones, wherein an object is generated in each of the zones in the first and second additive manufacturing operations; and
determining the calibrated energy level comprises determining a calibrated energy level for each of the fusing energy modules.

5. A method according to claim 4 in which each generated object of the plurality of objects in the first and second additive manufacturing operation is generated based on the same or similar object model data.

6. A method according to claim 4 in which each object generated in the first additive manufacturing operation corresponds to an object generated in the second additive manufacturing operation, wherein corresponding objects are generated based on the same object model data and in a same zone of the additive manufacturing apparatus.

7. A method according to claim 4 further comprising determining an average weight of a set of objects associated with a zone of the additive manufacturing apparatus.

8. A method according to claim 1 in which the indication of the extent of fusion comprises a weight of the object.

9. A method according to claim 1 further comprising performing, by additive manufacturing apparatus, the first and second additive manufacturing operations.

10. An apparatus comprising processing circuitry, the processing circuitry comprising a data module and an inference module, wherein
the data module is to acquire:
first fusing data indicative of a degree of fusion of build material in a first set of objects generated in a first additive manufacturing operation in which fusing energy modules are powered at a first power level,
second fusing data indicative of a degree of fusion of build material of a second set of objects generated in a second additive manufacturing operation in which fusing energy modules are powered at a second power level, and
an energy distribution matrix indicative of a contribution of each fusing energy module to generation of each object and wherein
the inference model is to infer, from the first fusing data; the second fusing data and the energy distribution matrix, a power level for each of the fusing energy modules in a subsequent additive manufacturing operation.

11. Apparatus according to claim 10 further comprising additive manufacturing apparatus to generate objects using additive manufacturing, the additive manufacturing apparatus comprising:
a plurality of fusing energy modules; and
a controller to control the plurality of fusing energy modules.

12. Apparatus according to claim 10, in which the first fusing data and second fusing data comprises data indicative of the weight of objects generated in the first and second additive manufacturing operations respectively, wherein the inference module is to infer the power level for the fusing energy modules in a subsequent additive manufacturing operation based on a linear regression of the weight data and an intended weight value.

13. A machine-readable medium comprising instructions which, when executed by a processor, cause the processor to:
control an additive manufacturing apparatus to generate a first instance of an object using a first power level for each of a plurality of fusing energy modules of the additive manufacturing apparatus;
control the additive manufacturing apparatus to generate a second instance of the object using a second, different, power level for each of the plurality of fusing energy modules;
determine the weights of the first and second instances of the object and, based on the weights and the energy contributed by the fusing energy modules to generating the first and second objects, determine a power level for the fusing energy modules in a subsequent build operation.

14. The machine-readable medium of claim 13, wherein:
the instructions to control an additive manufacturing apparatus to generate a first instance of the object comprises instructions to control the additive manufacturing apparatus to generate a set of first instances of objects, wherein each first instance of an object is generated in an associated zone of the additive manufacturing apparatus; and
the instructions to control an additive manufacturing apparatus to generate a second instance of the object comprises instructions to control the additive manufacturing apparatus to generate a set of second instances of objects, wherein each second instance of an object is generated in a location corresponding to a location of an object of the set of first instances.

15. The machine-readable medium of claim 14, further comprising instructions to determine the energy contributed by each fusing energy module to each zone of the additive manufacturing apparatus and thereby determine an indication of the energy contributed by each fusing energy module to generating each object.
